(19) United States
(12) Patent Application Publication
(10) Pub. No.: US 2026/0219681 A1
(43) Pub. Date: Jul. 30, 2026

(54) AUTOMATIC POOL CLEANING DEVICE AND ITS CONTROLLING METHOD

(71) Applicant: AIPER GLOBAL PTE. LTD., Singapore (SG)

(72) Inventors: Qingxiang Song, Shenzhen (CN); Qi Huang, Shenzhen (CN); Botao Yang, Shenzhen (CN)

(21) Appl. No.: 19/303,520

(22) Filed: Aug. 19, 2025

(30) Foreign Application Priority Data
Jan. 24, 2025 (CN) 202510122584.8

(51) Int. Cl. G05D 1/648; E04H 4/16; G05D 105/10; G05D 107/00

(52) U.S. Cl. CPC G05D 1/648; E04H 4/1654; G05D 2105/10; G05D 2107/29

(57) ABSTRACT

Disclosed are a pool automatic cleaning device and its controlling method. In an example, the method includes: determining a cleaning mode of the pool automatic cleaning device; determining a cleaning strategy of the pool automatic cleaning device for a pool with a platform based on the determined cleaning mode; and controlling the pool automatic cleaning device to clean a bottom surface and/or a side wall of the pool according to the determined cleaning strategy.

### CROSS-REFERENCE

The present disclosure claims a benefit of, and priority to Chinese Patent Application No. 202510122584.8 filed on Jan. 24, 2025, the disclosure of which is hereby expressly incorporated by reference herein in its entirety.

### TECHNICAL FIELD

The present disclosure relates to an automatic pool cleaning device and a method for controlling the automatic pool cleaning device in a field of automatic cleaning.

### BACKGROUND

An automatic pool cleaning device may be utilized to automatically clean pool facilities such as swimming pools. For example, the automatic pool cleaning device may be configured to run its cleaning mechanisms while moving on the bottom, wall, or surface of the pool, to filter water and absorb dirt.

### BRIEF DESCRIPTION OF THE DRAWINGS

FIG. 1 schematically shows an example of an automatic pool cleaning device in an aspect.

FIG. 2 schematically shows an example of a method for controlling the automatic pool cleaning device in an aspect.

FIG. 3 schematically shows an example of an execution process of the method for controlling the automatic pool cleaning device in an aspect.

FIG. 4 schematically shows an example of an execution process of the method for controlling the automatic pool cleaning device in an aspect.

FIG. 5 schematically shows an example of an execution process of the method for controlling the automatic pool cleaning device in an aspect.

### DETAILED DESCRIPTION

Aspects of the present disclosure will be described hereinafter in detail with reference to accompany drawings. In the drawings, the same reference numbers will be assigned to the same or equivalent parts for which descriptions will not be repeated.

In some pools, one or more platforms higher than the bottom surface of the pool may be arranged. The automatic pool cleaning device may fall off such platforms during cleaning, and there may be little chance (or even no chance) for it to climb on the platform again, possibly leaving a large area uncleaned.

The automatic pool cleaning device in the aspect of the present disclosure is configured to have a capacity of cleaning the pool with platforms, and may select different cleaning strategies according to different working modes, to ensure a cleaning coverage.

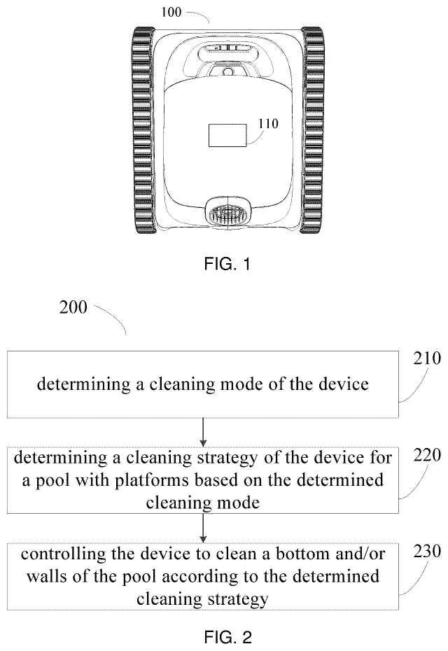

FIG. 1 schematically shows an exemplary automatic pool cleaning device 100 in an aspect, which is also referred to simply as “device 100” hereinafter. The device 100 may include or may be configured with a housing, a water inlet, a water outlet, a water pump, a filtering apparatus, a driving mechanism, and so on. For example, the driving mechanism may include a driving force mechanism for providing driving force, such as a motor and a water pump, and may also include a traveling mechanism for driving the device 100 to move when being driving by the driving force mechanism, such as a traveling wheel, a crawler, a water nozzle, a propeller, or the like. For example, while the device 100 is moving on the bottom of the pool, the wall of the pool or the water surface by its driving mechanism, water in the pool and garbage in the water may be absorbed into the device via the water inlet of the device by the water pump in the device, and then the water filtered by the filtering apparatus in the device may be discharged into the pool via the water outlet of the device by the water pump.

As shown in FIG. 1, a controller 110 is configured in the device 100. The controller 110 may include any circuit and/or component capable of processing data and/or executing instructions and suitable for the device 100, such as a central processing unit (CPU), a graphics processing unit (GPU), a field programmable gate array (FPGA). For example, the controller 110 may be configured to perform data processing and/or controlling related to cleaning tasks and/or other functions of the device 100, based on programs stored in a memory in the device 100, and/or signals and/or instructions from a control panel or control terminal of the device 100, and/or sensing data from one or more sensors of the device 100, and so on.

FIG. 2 schematically shows an exemplary method 200 for controlling the device 100 in an aspect. For example, the method 200 may be executed by the controller 110 of the device 100, and may include: a step 210 for determining a cleaning mode of the device 100; a step 220 for determining a cleaning strategy for the device 100 to clean the pool with at least one platform, based on the determined cleaning mode; and a step 230 for controlling the device 100 to clean the bottom surface and/or the side wall of the pool based on the determined cleaning strategy.

By the method 200, the device 100 may be enabled to clean the pool with platforms according to different working modes and different cleaning strategies, thus ensuring the cleaning coverage.

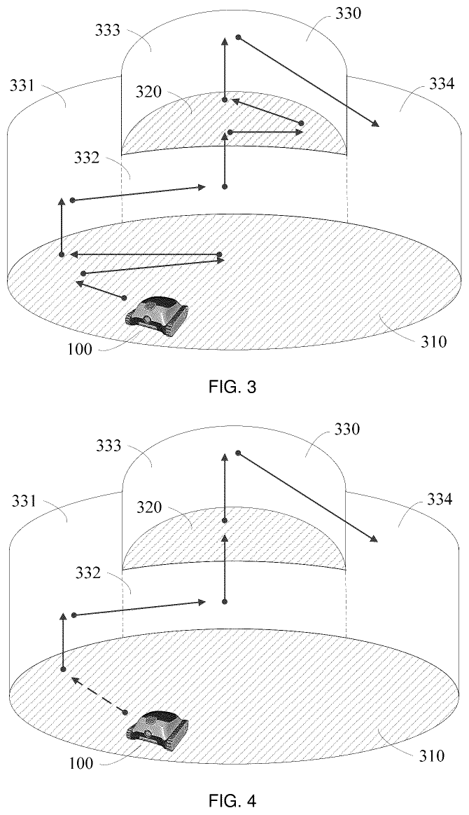

Details of the method 200 and an example of execution processes will be described below with reference to FIG. 3 to FIG. 5.

In the examples as shown in FIG. 3 to FIG. 5, the pool is equipped with a bottom surface 310, a platform 320 higher than the bottom surface 310, and a side wall 330, wherein the side wall 330 includes a side wall part (also referred to as a “first part” herein) 331 on one side (e.g., the left side) of the platform 320, a side wall part (also referred to as a “second part” herein) 332 below the platform 320, a side wall part (also referred to as a “third part” herein) 333 above the platform 320, and a side wall part (also referred to as a “fourth part” herein) 334 on the other side (e.g. the right side) of the platform 320.

The cleaning modes supported by the device 100 may include at least one of: a first mode for cleaning both the bottom surface and the side wall of the pool; a second mode of cleaning only the side wall of the pool; or a third mode for cleaning only the bottom surface of the pool. For example, a user of the device 100 may set the cleaning mode of the device 100 through a control panel and/or control terminal of the device 100.

If it is determined in the step 210 that the current cleaning mode of the device 100 is the first mode, the controller 110 may determine a first cleaning strategy corresponding to the first mode in the step 220, and then control the device 100 to perform cleaning tasks according to the first cleaning strategy in the step 230.

According to the first cleaning strategy, as shown by the arrows in FIG. 3, the device 100 may be controlled to clean the bottom surface 310 first. After cleaning the bottom surface 310, the device 100 is controlled to clean the first part 331 of the side wall 330.

After cleaning the first part 331 of the side wall 330, the device 100 may be controlled to move to the second part 332 of the side wall 330, and to clean the second part 332 of the side wall 330.

During cleaning the second part 332 of the side wall 330, the device 100 may detect platforms for example by its downward detector. For example, it may be determined that the device 100 has arrived upward at an edge of a platform in the pool when cleaning the second part 332 of the side wall 330, in a case where the data detected by the downward detector suffers an abrupt change, such as a sudden change from a state where the downward detector can detect the side wall 300 as an obstacle to a state where the downward detector fails to detect the side wall 330, or an abrupt increase (for example, suddenly exceeding a predetermined threshold) in a distance from the side wall 330 detected by the downward detector.

In a case where the platform 320 is detected during cleaning the second part 332 of the side wall 330, for example, the controller 110 may determine and record a height of the platform 320 or a height relative to the bottom surface 310 based on sensed data from sensors of the device 100, such as a depth sensor or a water pressure sensor. Further, the controller 110 may also determine and record a direction and position of the platform 320 relative to the bottom surface 310 based on changes of yaw angles of the device during moving from the bottom surface 310 to the platform 320.

In a case where the platform 320 is detected during cleaning the second part 332 of the side wall 330, the device 100 may be controlled to climb onto the platform 320 along the second part 332 of the side wall 330 after cleaning the second part 332 of the side wall 330 and clean the platform 320, where a cleaning width of the second part 332 of the side wall 330 may be the same as a width of the platform 320, for example.

After cleaning the platform 320, the device 100 may be controlled to continue to move from the platform 320 to the third part 333 of the side wall 330, and to clean the third part 333 of the side wall 330. For example, a cleaning width of the third part 333 of the side wall 330 may be the same as the width of the platform 320.

After cleaning the third part 333 of the side wall 330, the device 100 may be controlled to continue to move to the fourth part 334 of the side wall 330, and to clean the fourth part 334 of the side wall 330.

During cleaning various parts of the side wall 330, for example, operations similar to those described above may be performed in an iterative manner. For example, in a case where there is another platform above the platform 320, the platform 320 may be regarded as the bottom surface in the above process, and the above process may be repeated from the platform 320. Thus, the device 100 may be enabled to cope with a pool with a more complicated platform structure.

If it is determined in the step 210 that the current cleaning mode of the device 100 is the second mode, the controller 110 may determine a second cleaning strategy corresponding to the second mode in the step 220, and then control the device 100 to perform cleaning task according to the second cleaning strategy in the step 230.

According to the second cleaning strategy, as shown by the arrows in FIG. 4 (where the dashed arrows indicate that the device will move through the corresponding area without cleaning), in a case where the device 100 is initially located on the bottom surface 310, the device 100 may be controlled to move the first part 331 of the side wall 330 from the bottom surface 310, and to clean the first part 331 of the side wall 330.

After cleaning the first part 331 of the side wall 330, the device 100 may be controlled to move to the second part 332 of the side wall 330, and to clean the second part 332 of the side wall 330.

During cleaning the second part 332 of the side wall 330, the device 100 may detect platforms for example by its downward detector. For example, it may be determined that the device 100 has arrived upward at an edge of a platform in the pool when cleaning the second part 332 of the side wall 330, in a case where the data detected by the downward detector suffers an abrupt change, such as a sudden change from a state where the downward detector can detect the side wall 300 as an obstacle to a state where the downward detector fails to detect the side wall 330, or an abrupt increase (for example, suddenly exceeding a predetermined threshold) in a distance from the side wall 330 detected by the downward detector.

In a case where the platform 320 is detected during cleaning the second part 332 of the side wall 330, for example, the controller 110 may determine and record a height of the platform 320 or a height relative to the bottom surface 310 based on sensed data from sensors of the device 100, such as a depth sensor or a water pressure sensor. Further, the controller 110 may also determine and record a direction and position of the platform 320 relative to the bottom surface 310 based on changes of yaw angles of the device during moving from the bottom surface 310 to the platform 320.

In the case that the platform 320 is detected during cleaning the second part 332 of the side wall 330, the device 100 may be controlled to climb onto the platform 320 along the second part 332 of the side wall 330 after cleaning the second part 332 of the side wall 330, and to move to the third part 333 of the side wall via the platform 320 without cleaning the platform 320. For example, the cleaning width of the second part 332 of the side wall 330 may be the same as the width of the platform 320. For example, the cleaning width of the third part 333 of the side wall 330 may be the same as the width of the platform 320.

After cleaning the third part 333 of the side wall 330, the device 100 may be controlled to continue to move to the fourth part 334 of the side wall 330, and to clean the fourth part 334 of the side wall 330.

During cleaning various parts of the side wall 330, for example, operations similar to those described above may be performed in an iterative manner. For example, in a case where there is another platform above the platform 320, the platform 320 may be regarded as the bottom surface in the above process, and the above process may be repeated from the platform 320. Thus, the device 100 may be enabled to cope with a pool with a more complicated platform structure.

If it is determined in the step 210 that the current cleaning mode of the device 100 is the third mode, the controller 110 may determine a third cleaning strategy corresponding to the third mode in the step 220, and then control the device 100 to perform cleaning task according to the third cleaning strategy in the step 230.

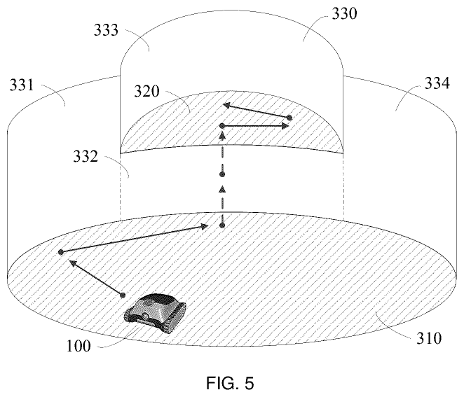

According to the third cleaning strategy, as shown by the arrows in FIG. 5, the device 100 may be controlled to clean the bottom surface 310 first.

For example, in the absence of information about the platform in the pool and/or map data about the pool, the device 100 may be controlled to build an outline map of the pool by any suitable method, such as Simultaneous Localization and Mapping (SLAM), during cleaning the bottom surface 310.

In a case where there is information on the platforms in the pool, for example, in a case where the information on the platforms in the pool (e.g., the height and/or relative direction/position of each platform in the pool, etc.) has been detected and recorded during the previous cleaning task in the first cleaning mode or the second cleaning mode, it may be determined whether there is still the platform 320 to be cleaned after cleaning the bottom surface 310. For example, it may be determined whether there is still a platform to be cleaned and/or which platforms have not been cleaned, according to the number of cleaned platforms and/or heights of the respective cleaned platforms.

In a case where there is still the platform 320 to be cleaned after cleaning the bottom surface 310, the device 100 may be controlled to move to the platform 320, and to clean the platform 320, according to information on the direction and position of the platform 320 relative to the bottom surface 310.

In a case where there is no platform 320 to be cleaned after cleaning the bottom surface 310, the cleaning task may be finished.

According to the third cleaning strategy, the side wall 330 will not be cleaned.

As described above, by the method 200, the device 100 may be enabled to clean the pool with the platforms according to different working modes and different cleaning strategies, thus ensuring the cleaning coverage.

In the automatic pool cleaning device and the method for controlling the automatic pool cleaning device in aspects, a cleaning strategy is determined for the pool automatic cleaning device based on the cleaning mode of the pool automatic cleaning device, to adapt to the environment in the pool with multiple platforms, so that the pool automatic cleaning device may clean the bottom surface and/or side wall of the pool according to the cleaning strategy, thereby improving the cleaning coverage.

In some aspects, disclosed is a method for controlling an automatic pool cleaning device, comprising: determining a cleaning mode of the pool automatic cleaning device; determining a cleaning strategy for the pool automatic cleaning device to clean a pool with a platform, based on the determined cleaning mode; and controlling the pool automatic cleaning device to clean a bottom surface and/or a side wall of the pool according to the determined cleaning strategy.

In one or more aspects, the cleaning strategy in a case where the cleaning mode corresponds to a mode for cleaning both a bottom surface and a side wall of the pool comprises: controlling the automatic pool cleaning device to clean the bottom surface; and controlling the automatic pool cleaning device to clean a first part of the side wall after cleaning the bottom surface, the first part being at one side of the platform.

In one or more aspects, the cleaning strategy in a case where the cleaning mode corresponds to a mode for cleaning both a bottom surface and a side wall of the pool further comprises: controlling the automatic pool cleaning device to move to a second part of the side wall after cleaning the first part, the second part being below the platform; in a case where the platform is sensed during cleaning the second part, controlling the automatic pool cleaning device to climb onto the platform along the second part after cleaning the second part; controlling the automatic pool cleaning device to clean the platform; controlling the automatic pool cleaning device to move from the platform to a third part of the side wall after cleaning the platform, the third part being above the platform; and controlling the automatic pool cleaning device to clean the third part.

In one or more aspects, a width of the cleaned second part is the same as a width of the platform, and/or a width of the cleaned third part is the same as the width of the platform.

In one or more aspects, the cleaning strategy in a case where the cleaning mode corresponds to a mode for cleaning both a bottom surface and a side wall of the pool further comprises: controlling the automatic pool cleaning device to move to a fourth part of the side wall after cleaning the third part, the fourth part being on another side of the platform; and controlling the automatic pool cleaning device to clean the fourth part.

In one or more aspects, the cleaning strategy in a case where the cleaning mode corresponds to a mode for cleaning only a side wall of the pool comprises: controlling the automatic pool cleaning device to clean a first part of the side wall, the first part being at one side of the platform.

In one or more aspects, the cleaning strategy in a case where the cleaning mode corresponds to a mode for cleaning only a side wall of the pool further comprises: controlling the automatic pool cleaning device to move to a second part of the side wall after cleaning the first part, the second part being below the platform; in a case where the platform is sensed during cleaning the second part, controlling the automatic pool cleaning device to climb onto the platform along the second part after cleaning the second part; controlling the automatic pool cleaning device to move from the platform to a third part of the side wall, the third part being above the platform; and controlling the automatic pool cleaning device to clean the third part.

In one or more aspects, the cleaning strategy in a case where the cleaning mode corresponds to a mode for cleaning only a side wall of the pool further comprises: controlling the automatic pool cleaning device to move to a fourth part of the side wall after cleaning the third part, the fourth part being on another side of the platform; and controlling the automatic pool cleaning device to clean the fourth part.

In one or more aspects, the cleaning strategy in a case where the cleaning mode corresponds to a mode for cleaning only a bottom surface of the pool comprises: controlling the automatic pool cleaning device to clean the bottom surface; and in a case where the platform is still to be cleaned after cleaning the bottom surface, controlling the automatic pool cleaning device to move to the platform based on an orientation information of the platform relative to the bottom surface, and to clean the platform.

Also disclosed is an automatic pool cleaning device comprising a controller configured to perform the above method.

The basic principles of the present disclosure have been described above in connection with the aspects. However, it is appreciated that the advantages, benefits, effects, and so on, which have been mentioned herein, are only examples rather than limitations, and these advantages, benefits, effects, and so on should not be considered as necessary for each aspect of this disclosure. In addition, the foregoing details are only for the purpose of illustration and easy understanding, rather than limitations, and the foregoing details do not limit that the present disclosure must be implemented with the foregoing details.

The block diagrams of devices, apparatuses, equipment and systems involved in this disclosure are only illustrative examples and are not intended to require or imply that they must be connected, arranged or configured in the manners shown in the block diagrams. In different aspects, these devices, apparatuses, equipment and systems may be connected, arranged or configured in any suitable manners.

In addition, wordings such as “including”, “comprising” and “having” are open words, which mean and is interchangeable with the wording “including but not limited to”. The wordings “or” and “and” herein refer to and may be interchangeable with “and/or” unless the context clearly indicates otherwise. The wording “such as” herein refers to and may be interchangeable with the phrase “such as but not limited to”.

It is appreciated that in the apparatuses, equipment and methods of the present disclosure, each component or step may be decomposed and/or recombined. Any decomposition and/or recombination should be regarded as equivalents of the present disclosure.

In this disclosure, modifiers without quantifiers such as “first” and “second” are intended to distinguish different elements, components, circuits, modules, apparatuses, steps, and are not used to emphasize an order, positional relationship, importance, priority level, or the like. Sometimes, modifiers with quantifiers such as “first piece of” and “second piece of” may be used to emphasize the order, positional relationship, importance, priority level and so on for different components, components, circuits, modules, apparatuses, steps.

The foregoing description has been presented for purposes of illustration and description. This description is not intended to limit the aspects of the present disclosure to the forms disclosed herein. Although several example aspects and aspects have been described above, those skilled in the art may recognize some variations, modifications, changes, additions and sub-combinations thereof.

What is claimed is:

1. A method for controlling an automatic pool cleaning device, comprising:
determining a cleaning mode of the pool automatic cleaning device;
determining a cleaning strategy for the pool automatic cleaning device to clean a pool with a platform, based on the determined cleaning mode; and
controlling the pool automatic cleaning device to clean a bottom surface and/or a wall of the pool according to the determined cleaning strategy.

2. The method of claim 1, wherein the cleaning strategy in a case where the cleaning mode corresponds to a mode for cleaning both a bottom surface and a side wall of the pool comprises:
controlling the automatic pool cleaning device to clean the bottom surface; and
controlling the automatic pool cleaning device to clean a first part of the side wall after cleaning the bottom surface, the first part being at one side of the platform.

3. The method of claim 2, wherein the cleaning strategy further comprises:
controlling the automatic pool cleaning device to move to a second part of the side wall after cleaning the first part, the second part being below the platform;
in a case where the platform is sensed during cleaning the second part, controlling the automatic pool cleaning device to climb onto the platform along the second part after cleaning the second part;
controlling the automatic pool cleaning device to clean the platform;
controlling the automatic pool cleaning device to move from the platform to a third part of the side wall after cleaning the platform, the third part being above the platform; and
controlling the automatic pool cleaning device to clean the third part.

4. The method of claim 3, wherein a width of the cleaned second part is the same as a width of the platform, and/or a width of the cleaned third part is the same as the width of the platform.

5. The method of claim 3, wherein the cleaning strategy further comprises:
controlling the automatic pool cleaning device to move to a fourth part of the side wall after cleaning the third part, the fourth part being on another side of the platform; and
controlling the automatic pool cleaning device to clean the fourth part.

6. The method of claim 1, wherein the cleaning strategy in a case where the cleaning mode corresponds to a mode for cleaning only a side wall of the pool comprises:
controlling the automatic pool cleaning device to clean a first part of the side wall, the first part being at one side of the platform.

7. The method of claim 6, wherein the cleaning strategy further comprises:
controlling the automatic pool cleaning device to move to a second part of the side wall after cleaning the first part, the second part being below the platform;
in a case where the platform is sensed during cleaning the second part, controlling the automatic pool cleaning device to climb onto the platform along the second part after cleaning the second part;
controlling the automatic pool cleaning device to move from the platform to a third part of the side wall, the third part being above the platform; and
controlling the automatic pool cleaning device to clean the third part.

8. The method of claim 7, wherein the cleaning strategy further comprises:
controlling the automatic pool cleaning device to move to a fourth part of the side wall after cleaning the third part, the fourth part being on another side of the platform; and
controlling the automatic pool cleaning device to clean the fourth part.

9. The method of claim 1, wherein the cleaning strategy in a case where the cleaning mode corresponds to a mode for cleaning only a bottom surface of the pool comprises:
controlling the automatic pool cleaning device to clean the bottom surface; and
in a case where the platform is still to be cleaned after cleaning the bottom surface, controlling the automatic pool cleaning device to move to the platform based on an orientation information of the platform relative to the bottom surface, and to clean the platform.

10. An automatic pool cleaning device, comprising:
a controller configured to perform instructions to determine a cleaning mode of the pool automatic cleaning device, to determine a cleaning strategy for the pool automatic cleaning device to clean a pool with a platform, based on the determined cleaning mode, and to control the pool automatic cleaning device to clean a bottom surface and/or a side wall of the pool according to the determined cleaning strategy.

11. The automatic pool cleaning device of claim 10, wherein the cleaning strategy in a case where the cleaning mode corresponds to a mode for cleaning both a bottom surface and a side wall of the pool comprises:
controlling the automatic pool cleaning device to clean the bottom surface; and
controlling the automatic pool cleaning device to clean a first part of the side wall after cleaning the bottom surface, the first part being at one side of the platform.

12. The automatic pool cleaning device of claim 11, wherein the cleaning strategy further comprises:
controlling the automatic pool cleaning device to move to a second part of the side wall after cleaning the first part, the second part being below the platform;
in a case where the platform is sensed during cleaning the second part, controlling the automatic pool cleaning device to climb onto the platform along the second part after cleaning the second part;
controlling the automatic pool cleaning device to clean the platform;
controlling the automatic pool cleaning device to move from the platform to a third part of the side wall after cleaning the platform, the third part being above the platform; and
controlling the automatic pool cleaning device to clean the third part.

13. The automatic pool cleaning device of claim 12, wherein a width of the cleaned second part is the same as a width of the platform, and/or a width of the cleaned third part is the same as the width of the platform.

14. The automatic pool cleaning device of claim 12, wherein the cleaning strategy further comprises:
controlling the automatic pool cleaning device to move to a fourth part of the side wall after cleaning the third part, the fourth part being on another side of the platform; and
controlling the automatic pool cleaning device to clean the fourth part.

15. The automatic pool cleaning device of claim 10, wherein the cleaning strategy in a case where the cleaning mode corresponds to a mode for cleaning only a side wall of the pool comprises:
controlling the automatic pool cleaning device to clean a first part of the side wall, the first part being at one side of the platform.

16. The automatic pool cleaning device of claim 15, wherein the cleaning strategy further comprises:
controlling the automatic pool cleaning device to move to a second part of the side wall after cleaning the first part, the second part being below the platform;
in a case where the platform is sensed during cleaning the second part, controlling the automatic pool cleaning device to climb onto the platform along the second part after cleaning the second part;
controlling the automatic pool cleaning device to move from the platform to a third part of the side wall, the third part being above the platform; and
controlling the automatic pool cleaning device to clean the third part.

17. The automatic pool cleaning device of claim 16, wherein the cleaning strategy further comprises:
controlling the automatic pool cleaning device to move to a fourth part of the side wall after cleaning the third part, the fourth part being on another side of the platform; and
controlling the automatic pool cleaning device to clean the fourth part.

18. The automatic pool cleaning device of claim 10, wherein the cleaning strategy in a case where the cleaning mode corresponds to a mode for cleaning only a bottom surface of the pool comprises:
controlling the automatic pool cleaning device to clean the bottom surface; and
in a case where the platform is still to be cleaned after cleaning the bottom surface, controlling the automatic pool cleaning device to move to the platform based on an orientation information of the platform relative to the bottom surface, and to clean the platform.

19. The automatic pool cleaning device of claim 10, further comprising:
a downward detector configured to detect obstacles below the automatic pool cleaning device, wherein the controller is further configured to determine whether the automatic pool cleaning device has arrived at an edge of the platform, based on detected data from the downward detector.

20. The automatic pool cleaning device of claim 10, wherein the controller is further configured to determine and record a direction and position of platform relative to the bottom surface, based on changes of yaw angles of the automatic pool cleaning device during moving from the platform to the bottom surface.
